(19) United States
(12) Patent Application Publication
(10) Pub. No.: US 2026/0230351 A1
(43) Pub. Date: Aug. 6, 2026

(54) Wireless Circuitry with Cross-Protocol Object Detection

(71) Applicant: Apple Inc., Cupertino, CA (US)

(72) Inventor: Fnu Ishaq Basha Zakir Ahmed, Poway, CA (US)

(21) Appl. No.: 19/046,206

(22) Filed: Feb. 5, 2025

(51) Int. Cl. H04L 25/02; H04L 5/00; H04W 76/15

(52) U.S. Cl. CPC H04L 25/0212; H04L 5/0007; H04W 76/15

(57) ABSTRACT

An electronic device may include wireless circuitry. The wireless circuitry may include a first chipset that implements a first communications protocol and a second chipset that implements a second communications protocol. The first and second chipsets may perform cross-protocol object detection operations to detect an external object in the vicinity of the wireless circuitry. This may involve the transmission of a radio-frequency signal by the first chipset over the first antenna using the first communications protocol. The second chipset may receive the radio-frequency signal over the second antenna using the second communications protocol. The second chipset may generate baseband samples based on the received radio-frequency signal using the second protocol. Processing circuitry may modify the baseband samples to obtain radio-frequency channel impulse response samples using at least a partial version of the first communication protocol and may detect the object based on the channel impulse response.

### FIELD

This disclosure relates generally to electronic devices, including electronic devices with wireless circuitry.

### BACKGROUND

Electronic devices can be provided with wireless communications capabilities. An electronic device with wireless communications capabilities includes transceiver circuitry and antennas. The transceiver circuitry uses the antennas to transmit and receive radio-frequency signals. If care is not taken, external objects can block, detune, or otherwise interfere with the transmission or reception of radio-frequency signals by one or more of the antennas.

### SUMMARY

An electronic device may include wireless circuitry. The wireless circuitry may include a first chipset that implements a first communications protocol and a first radio access technology (RAT). The wireless circuitry may include a second chipset that implements a second communications protocol that is different from the first communications protocol and a second RAT that is different from the first RAT. The first chipset may, if desired, use the first communications protocol to convey first wireless data with first external equipment. The second chipset may, if desired, use the second communications protocol to convey second wireless data with second external equipment. The first and second chipsets may perform cross-protocol object detection operations to detect an external object in the vicinity of the wireless circuitry. This may involve the transmission of a radio-frequency signal by the first chipset over the first antenna using the first communications protocol. The second chipset may receive the radio-frequency signal over the second antenna using the second communications protocol. The second chipset may generate baseband samples based on the received radio-frequency signal using the second protocol. One or more processors may detect the object based on the baseband samples. For example, the second chipset or the one or more processors may generate a channel impulse response (CIR) from the received radio- frequency signal and may process the CIR to detect whether the external object is occluding one of the antennas.

An aspect of the disclosure provides circuitry. The circuitry can include a first antenna. The circuitry can include a transmitter communicatively coupled to the first antenna, wherein the transmitter implements a first radio access technology (RAT) and is configured to transmit a radio-frequency signal using the first RAT and the first antenna. The circuitry can include a second antenna. The circuitry can include a receiver communicatively coupled to the second antenna, wherein the receiver implements a second RAT that is different from the first RAT and is configured to receive, using the second antenna, the radio-frequency signal transmitted by the transmitter. The circuitry can include one or more processors configured to detect an external object based on the radio-frequency signal received by the receiver.

An aspect of the disclosure provides wireless communications circuitry. The wireless communications circuitry can include a first chipset configured to transmit, using a first antenna, a radio-frequency signal according to a first communications protocol. The wireless communications circuitry can include a second chipset configured to receive, using a second antenna and a second communications protocol that is different than the first communications protocol, the radio-frequency signal transmitted by the first chipset, and configured to generate baseband samples based on the radio-frequency signal received using the second communications protocol. The wireless communications circuitry can include one or more processors configured to detect an external object based on the baseband samples generated by the second chipset.

An aspect of the disclosure provides a method of operating wireless circuitry. The method can include transmitting, using a first modem and a first antenna, a radio-frequency signal according to a first wireless communications protocol. The method can include receiving, using a second modem and a second antenna, the radio-frequency signal according to a second wireless communications protocol that is different from the first wireless communications protocol. The method can include generating, using the second modem, baseband samples based on the received radio-frequency signal. The method can include detecting, using one or more processors, occlusion of the second antenna by an external object based on the baseband samples.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry in accordance with some embodiments.

FIG. 3 is a circuit diagram of illustrative wireless circuitry that includes different chipsets for performing cross-protocol object detection in accordance with some embodiments.

FIG. 4 is a circuit diagram of illustrative wireless circuitry that includes different chipsets and additional processing circuitry that generates a channel impulse response for performing cross-protocol object detection in accordance with some embodiments.

FIG. 5 is a flow chart of illustrative operations involved in performing cross-protocol object detection in accordance with some embodiments.

### DETAILED DESCRIPTION

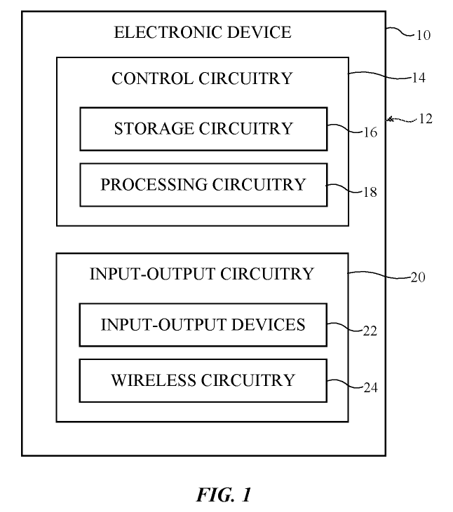

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display (e.g., that does not contain an embedded computer), a gaming device, a navigation device, an embedded system such as a system in which electronic equipment with a display is mounted in a kiosk or automobile, a wireless internet- connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, parts or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access- memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing wireless communications protocols (sometimes also referred to as communications protocols or communications standards). Communications protocols (standards) that may be implemented using control circuitry 14 include wireless local area network (WLAN) protocols (e.g., IEEE 802.11 protocols - sometimes referred to as Wi-Fi® such as a Wi-Fi 6 protocol, a Wi-Fi 7 protocol, or other Wi-Fi protocols), protocols for other short-range wireless communications links such as the Bluetooth® protocol or other wireless personal area network (WPAN) protocols, IEEE 802.11 ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), satellite navigation system protocols (e.g., global positioning system (GPS) protocols, global navigation satellite system (GLONASS) protocols, etc.), satellite communications (satcom) protocols, antenna-based spatial ranging protocols, optical communications protocols, or any other desired communications protocols. Each communications protocol may be associated with a corresponding radio access technology (RAT) that specifies the physical connection methodology used in implementing the protocol (e.g., used in transmitting and/or receiving radio-frequency signals under or according to the protocol).

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support or perform radio- frequency signal transmission and/or reception for device 10. Wireless circuitry 24 may be used for wireless communications. Wireless communications performed by wireless circuitry 24 may include or involve wireless data communications (e.g., where wireless data is carried by radio- frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, communicatively coupled to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.).

Wireless circuitry 24 may transmit and/or receive radio-frequency signals within a corresponding frequency band at radio frequencies (sometimes referred to herein as a communications band or simply as a "band"). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10- 100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra- wideband (UWB) frequency bands that operate under the IEEE 802.15.4 protocol and/or other ultra-wideband communications protocols, satellite communications (satcom) bands (e.g., an IEEE C band (4-8 GHz), S band (2-4 GHz), L band (1-2 GHz), X band (8-12 GHz), W band (75- 110 GHz), V band (40-75 GHz), K band (18-27 GHz), Kₐ band (26.5-40 GHz), Ku band (12-18 GHz), etc.), unlicensed bands, communications bands under the family of 3GPP wireless communications standards, communications bands under the IEEE 802.XX family of standards, and/or any other desired frequency bands of interest. Different communications protocols may utilize different frequency bands for conveying radio-frequency signals. In some cases, two or more communications protocols may utilize one or more of the same frequency bands for conveying radio-frequency signals.

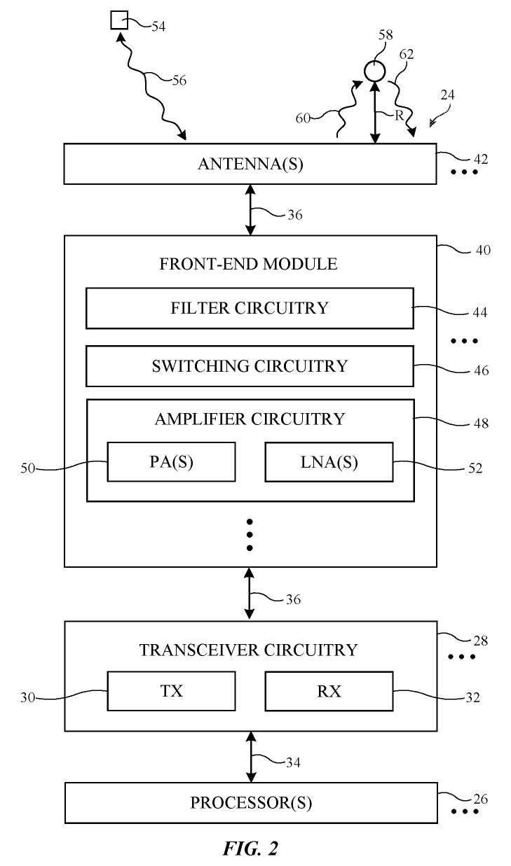

FIG. 2 is a diagram showing illustrative components within wireless circuitry 24. As shown in FIG. 2, wireless circuitry 24 may include a processor such as processor 26, radio- frequency (RF) transceiver circuitry such as radio-frequency transceiver 28, radio-frequency front end circuitry such as radio-frequency front end (RFFE) module (FEM) 40, and antenna(s) 42. Processor 26 may be a baseband processor, application processor, general purpose processor, microprocessor, microcontroller, digital signal processor, host processor, application specific signal processing hardware, or other type of processor. Processor 26 may be coupled to transceiver 28 over path 34. Transceiver 28 may be coupled to antenna 42 via radio-frequency transmission line path 36. Radio-frequency front end module 40 may be disposed on radio- frequency transmission line path 36 between transceiver 28 and antenna 42.

In the example of FIG. 2, wireless circuitry 24 is illustrated as including only a single processor 26, a single transceiver 28, a single front end module 40, and a single antenna 42 for the sake of clarity. In general, wireless circuitry 24 may include any desired number of processors 26, any desired number of transceivers 28, any desired number of front end modules 40, and any desired number of antennas 42. Each processor 26 may be coupled to one or more transceiver 28 over respective paths 34. Each transceiver 28 may include a transmitter circuit 30 configured to output uplink signals to antenna 42, may include a receiver circuit 32 configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge- coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

While performing wireless transmission, processor 26 may provide transmit signals (e.g., digital or baseband signals) to transceiver 28 over path 34. Transceiver 28 may further include circuitry for converting the transmit (baseband) signals received from processor 26. For example, transceiver circuitry 28 may include mixer circuitry for up-converting (or modulating) the transmit (baseband) signals to radio frequencies prior to transmission over antenna 42. The example of FIG. 2 in which processor 26 communicates with transceiver 28 is illustrative. In general, transceiver 28 may communicate with a baseband processor, an application processor, general purpose processor, a microcontroller, a microprocessor, or one or more processors within circuitry 18. Transceiver circuitry 28 may also include digital-to-analog converter (DAC) and/or analog-to-digital converter (ADC) circuitry for converting signals between digital and analog domains. Transceiver 28 may use transmitter (TX) 30 to transmit the radio-frequency signals over antenna 42 via radio-frequency transmission line path 36 and front end module 40. Antenna 42 may transmit the radio-frequency signals to external wireless equipment by radiating the radio-frequency signals into free space.

While performing wireless reception, antenna 42 may receive radio-frequency signals from the external wireless equipment. The received radio-frequency signals may be conveyed to transceiver 28 via radio-frequency transmission line path 36 and front end module 40. Transceiver 28 may include circuitry such as receiver (RX) 32 for receiving signals from front end module 40 and for converting the received radio-frequency signals into corresponding baseband signals. For example, transceiver 28 may include mixer circuitry for down-converting (or demodulating) the received radio-frequency signals to baseband frequencies prior to conveying the received signals to processor 26 over path 34.

Front end module (FEM) 40 may include radio-frequency front end circuitry that operates on the radio-frequency signals conveyed (transmitted and/or received) over radio- frequency transmission line path 36. FEM 40 may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers 50 and/or one or more low-noise amplifier circuits 52), signal attenuators, impedance matching circuitry (e.g., circuitry that helps to match the impedance of antenna 42 to the impedance of radio- frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip. If desired, amplifier circuitry 48 and/or other components in FEM 40 such as filter circuitry 44 may also be implemented as part of transceiver circuitry 28.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to tune the frequency response and wireless performance of antenna 42 over time.

Transceiver 28 may be separate from front end module 40. For example, transceiver 28 may be formed on another substrate such as the main logic board of device 10, a rigid printed circuit board, or flexible printed circuit that is not a part of front end module 40. Although control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processor 26 and/or portions of transceiver 28 (e.g., a host processor on transceiver 28) may form a part of control circuitry 14. Control circuitry 14 (e.g., portions of control circuitry 14 formed on processor 26, portions of control circuitry 14 formed on transceiver 28, and/or portions of control circuitry 14 that are separate from wireless circuitry 24) may provide control signals (e.g., over one or more control paths in device 10) that control the operation of front end module 40.

Transceiver 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband or impulse-based communications protocols, and/or any other desired radio-frequency transceiver circuitry for covering any other desired communications bands of interest.

In implementations where wireless circuitry 24 conveys radio-frequency signals in a UWB band under a UWB protocol, as one example, wireless circuitry 24 transmits the radio- frequency signals based on an impulse radio signaling scheme and containing a series of band- limited data pulses over time. The pulses in the UWB signals may be used to encode and convey wireless data. Each pulse may, for example, represent a corresponding bit of the wireless data. The sign (polarity) of each pulse may, for example, be used to represent a binary value of 1 or a binary value of 0 for its corresponding bit of wireless data. The wireless data may be organized into packets or frames such as ranging frames for use in performing wireless ranging and localization. The pulses in the UWB signals may represent the encoded bits of the ranging frames. A ranging frame may have a frame (packet) structure determined by the corresponding UWB communications protocol. The UWB signals may be conveyed in one or more UWB frequency bands such as a first UWB communications band at 6.5 GHz, a second UWB communications band at 8.0 GHz, and/or other UWB bands. The UWB signals may have relatively high bandwidths such as bandwidths between 499MHz and 1331 MHz, bandwidths greater than 500 MHz, bandwidths of around 500 MHz, etc. The presence of lower frequencies in the baseband may sometimes allow ultra-wideband signals to penetrate through objects such as walls.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

The term "convey radio-frequency signals" as used herein means the transmission and/or reception of the radio-frequency signals (e.g., for performing unidirectional and/or bidirectional wireless communications with external wireless communications equipment). Antennas 42 may transmit the radio-frequency signals by radiating the radio- frequency signals into free space (or to free space through intervening device structures such as a dielectric cover layer). Antennas 42 may additionally or alternatively receive the radio- frequency signals from free space (e.g., through intervening devices structures such as a dielectric cover layer). The transmission and reception of radio-frequency signals by antennas 42 each involve the excitation or resonance of antenna currents on an antenna resonating element in the antenna by the radio-frequency signals within the frequency band(s) of operation of the antenna.

In some implementations, wireless circuitry 24 may convey radio-frequency signals 56 with external equipment such as external communications equipment 54. External communications equipment 54 may include one or more other devices such as device 10 (e.g., a user equipment device), one or more wireless access points (APs), one or more wireless base stations (e.g., gNBs), and/or any other desired equipment that wirelessly transmits and/or receives radio-frequency signals 56. Radio-frequency signals 56 may, if desired, carry wireless communications data between wireless circuitry 24 and external communications equipment 54 (e.g., packets, symbols, frames, datagrams, data encoded in a series of impulses, etc.). Wireless communications data (sometimes also referred to simply as wireless data or data) may be conveyed bidirectionally or unidirectionally (e.g., in an uplink (UL) direction from wireless circuitry 42 to external communications equipment 54 and/or in a downlink (DL) direction from external communications equipment 54 to wireless circuitry 42). The wireless communications data may, for example, include wireless data associated with a telephone call, streaming media content, internet browsing, wireless data associated with software applications running on device 10, email messages, etc.

In addition to, or instead of, conveying wireless communications data with external communications equipment 54, wireless circuitry 24 may use antennas 42 to perform radio- frequency sensing operations (sometimes referred to herein as radio-based sensing, spatial ranging, radio detection and ranging (radar), object detection, or simply as sensing). The sensing operations may allow device 10 to detect (e.g., sense or identify) the presence, location, orientation, and/or velocity (motion) of objects external to device 10 such as external object 58. Detecting, sensing, or identifying the presence, location, orientation, and/or velocity (motion) of external object 58 at any given time or over a given time period is sometimes also referred to herein as object detection operations, detecting the external object or performing spatial ranging operations, ranging operations, radio-based sensing operations, or range detection. Object detection operations performed by wireless circuitry 24 may include, in some implementations, occlusion detection operations. Wireless circuitry 24 may perform occlusion detection operations to detect whether or not an external object 58 is blocking, overlapping, and/or otherwise occluding a corresponding antenna 42 in device 10. Wireless circuitry 24 may perform sensing operations over a relatively short range such as ranges of a few cm from antennas 42 or over longer ranges such as ranges of dozens of cm, a few meters, dozens of meters, etc.

External object 58 may be, for example, the ground, a building, part of a building, a wall, furniture, a ceiling, a person, a body part (e.g., the head, hand, finger, or other body part of the user of device 10 or other humans in the vicinity of device 10), an animal, a vehicle, a landscape or geographic feature, an obstacle, external communications equipment, another device of the same type as device 10 or a peripheral/accessory device such as a gaming controller, stylus (e.g., for providing input to a touch and/or force-sensitive display on device 10), or remote control, or any other physical object or entity that is external to device 10. External object 58 may be an animate (moving or living) object or an inanimate (stationary or non-living) object.

Control circuitry 14 (FIG. 1) may use the detected presence, location, orientation, and/or velocity of external object 58 (e.g., the result of object detection and/or occlusion detection operations performed by wireless circuitry 24) to perform any desired device operations. As examples, control circuitry 14 may use the detected presence, location (e.g., range R and/or position), orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 42 needs to be disabled, adjusted, tuned, or provided with a reduced maximum transmit power level (e.g., for satisfying regulatory limits on radio- frequency exposure, to mitigate an antenna 42 being blocked or occluded by external object 58, etc.), to determine how to steer a radio-frequency signal beam produced by antennas 42 (e.g., in implementations where antennas 42 include a phased array of antennas 42), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may perform radio-based sensing operations using radio- frequency sensing signals such as sensing signals 60 and/or sensing signals 62. Wireless circuitry 24 may transmit sensing signals 60 using one or more antennas 42. Wireless circuitry 24 may receive sensing signals 62 using one or more antennas 42. The received sensing signals 62 may include some or all of the sensing signals 60 that are transmitted by antenna(s) 42. The received sensing signals 62 may include, for example, electromagnetic energy from sensing signals 60 that has passed or coupled onto a second antenna 42 after transmission by a first antenna 42 and/or may include a reflected version of sensing signals 60 after sensing signals 60 have reflected off of external object 58. Control circuitry on device 10 may process information about or from the transmitted sensing signals 60 and/or the received sensing signals 62 to detect the presence, location, orientation, and/or velocity of external object 58 (e.g., to perform object detection operations).

In some implementations, wireless circuitry 24 includes a single chipset that performs object detection using transmitted and received radio-frequency signals (e.g., sensing signals 60 and 62). In these implementations, the chipset implements a single corresponding communications protocol (standard) and implements a single corresponding RAT (e.g., a RAT associated with the communications protocol). As examples, the chipset may perform object detection using a UWB protocol or a Wi-Fi protocol. In these implementations, the chipset is coupled to a first antenna 42 that transmits sensing signals 60 according to the communications protocol and is coupled to a second antenna 42 that receives sensing signals 62 according to that same communications protocol. As one example, the chipset may implement a channel impulse response (CIR) scheme to perform object detection (e.g., where a CIR is generated from the received and transmitted signals and processed to determine one or more characteristics of external object 58).

In this example, the transmitted and received signals are both compliant with the same communications protocol. A transmitter in the chipset transmits sensing signals 60 according to the communications protocol via the first antenna 42. A receiver in the chipset receives the transmitted sensing signals via the second antenna 42 (as sensing signals 62) according to the communications protocol. The receiver conditions the received signal before conversion to a digital signal using an analog-to-digital converter (ADC). Baseband (BB) signal processing circuitry extracts symbols (or message bits) that were transmitted by the transmitter, which may be specific to the corresponding communications protocol. The BB signal processing circuity performs a channel estimation (CE) using pilot symbols embedded within a predefined frame structure of the communications protocol to extract the CIR of the received signal. The CE or the CIR is used to undo the harsh effects of the wireless channel on the received signal. However, this type of implementation requires a single chipset to communicate using at least two different antennas 42, which can increase the area consumed by wireless circuitry 24 (e.g., limiting space in device 10 for other components), can increase the cost of wireless circuitry 24, and can limit the power efficiency of wireless circuitry 24.

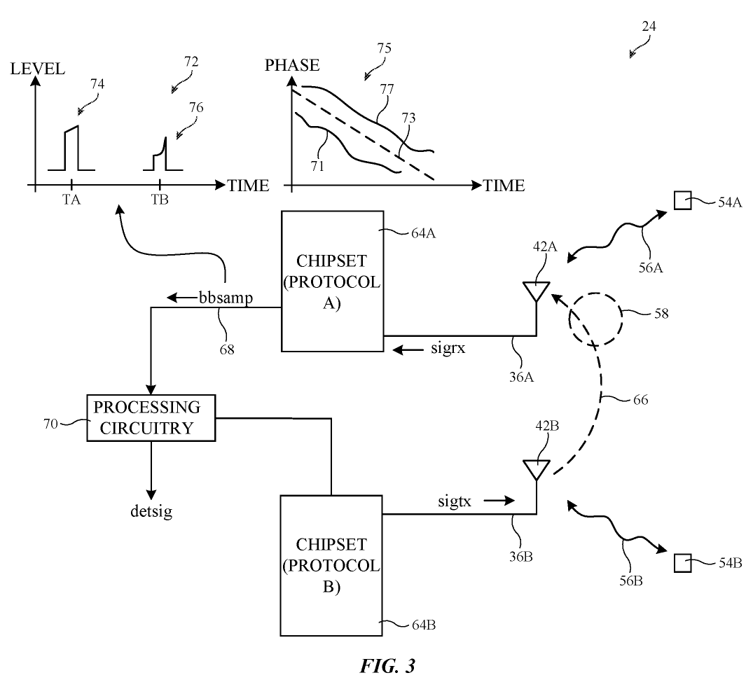

To mitigate these issues, wireless circuitry 24 may perform cross-protocol (CP) object detection on external object 58. FIG. 3 is a diagram showing one example of how wireless circuitry 24 may include circuitry that performs CP object detection on external object 58. As shown in FIG. 3, wireless circuitry 24 may include at least a first chipset 64A and a second chipset 64B. Chipset 64A may be communicatively coupled to a first antenna 42A over a first radio-frequency transmission line path 36A. Chipset 64B may be communicatively coupled to a second antenna 42B over a second radio-frequency transmission line path 36B.

Chipset 64A may include a first transceiver (e.g., a first transceiver 28 of FIG. 2) that includes a first receiver (e.g., a first receiver 32 of FIG. 2) and that optionally includes a first transmitter (e.g., a first transmitter 30 of FIG. 2). If desired, chipset 64A may also include first baseband circuitry (e.g., in processor(s) 26 of FIG. 2) that is communicatively coupled to the first transceiver over a first baseband path (e.g., a first path 34 of FIG. 2). If desired, chipset 64A may also include a first FEM (e.g., a first FEM 40 of FIG. 2) disposed on radio-frequency transmission line path 36A. The components of chipset 64A may be integrated into a first set of one or more integrated circuit (IC) chips or packages (e.g., chipset 64A may include as few as a single IC chip). Chipset 64A is sometimes also referred to herein as modulator-demodulator (modem) 64A.

Chipset 64B may include a second transceiver (e.g., a second transceiver 28 of FIG. 2) that includes a second transmitter (e.g., a second transmitter 30 of FIG. 2) and that optionally includes a second receiver (e.g., a second receiver 32 of FIG. 2). If desired, chipset 64B may also include second baseband circuitry (e.g., in processor(s) 26 of FIG. 2) that is communicatively coupled to the second transceiver over a second baseband path (e.g., a second path 34 of FIG. 2). If desired, chipset 64B may also include a second FEM (e.g., a second FEM 40 of FIG. 2) disposed on radio-frequency transmission line path 36B. Alternatively, chipsets 64A and 64B may share a single FEM (e.g., a single FEM that includes a first set of components that operate on signals conveyed by chipset 64A and that includes a second set of components that operate on signals conveyed by chipset 64B). The components of chipset 64B may be integrated into a second set of one or more integrated circuit (IC) chips or packages (e.g., different from the IC chips or packages used to form chipset 64A). Chipset 64B may include, for example, as few as a single IC chip. Chipset 64B is sometimes also referred to herein as modem 64B.

The hardware of chipset 64A and/or software stored on and/or executed by chipset 64A may implement a first wireless communications protocol (standard) such as protocol A. Chipset 64A may also implement a first RAT corresponding to protocol A (sometimes also referred to herein as first radio access technology RATA). If desired, chipset 64A may generate wireless data for transmission according to, under, using, and/or based on protocol A. Chipset 64A may include a transmitter that generates radio-frequency signals (e.g., carrying the wireless data) according to, under, using, and/or based on protocol A and radio access technology RATA. Chipset 64A may transmit the radio-frequency signals over antenna 42A and radio-frequency transmission line path 36A in a frequency band selected from a first set of frequency bands associated with protocol A and radio access technology RATA (e.g., protocol A and radio access technology RATA may specify that radio-frequency signals are to be transmitted in the first set of frequency bands). If desired, chipset 64A may transmit radio-frequency signals that do not carry wireless data. If desired, chipset 64A may forego transmission of radio-frequency signals (e.g., chipset 64A may include a receiver that receives radio-frequency signals and may not include any transmitters that transmit radio-frequency signals).

Chipset 64A may include a receiver that receives radio-frequency signals over antenna 42A and radio-frequency transmission line path 36A. The receiver may receive the radio- frequency signals according to, under, using, and/or based on protocol A and radio access technology RATA. Chipset 64A may recover, decode, demodulate, and/or otherwise identify wireless data and/or other baseband data (e.g., a stream of baseband data samples) from the received radio-frequency signals according to, under, using, and/or based on protocol A. Protocol A may be a UWB protocol, a WLAN protocol (e.g., a Wi-Fi 6 or Wi-Fi 7 protocol), a cellular telephone protocol, a device-to-device (D2D) protocol, a satellite navigation protocol, a satellite communications protocol, or any other desired wireless communications protocol.

On the other hand, the hardware of chipset 64B and/or software stored on and/or executed by chipset 64B may implement a second wireless communications protocol (standard) such as protocol B. Protocol B of chipset 64B is different than the protocol A of chipset 64A. Chipset 64B may also implement a second RAT corresponding to protocol B (sometimes also referred to herein as second radio access technology RATB). The second RAT of chipset 64B is different from the first RAT of chipset 64A. If desired, chipset 64B may generate wireless data for transmission according to, under, using, and/or based on protocol B. Chipset 64B may include a transmitter that generates radio-frequency signals (e.g., carrying the wireless data) according to, under, using, and/or based on protocol B and radio access technology RATB. Chipset 64B may transmit the radio-frequency signals over antenna 42B and radio-frequency transmission line path 36B in a frequency band selected from a second set of frequency bands associated with protocol B and radio access technology RATB (e.g., protocol B and radio access technology RATB may specify that radio-frequency signals are to be transmitted in the first set of frequency bands). The second set of frequency bands associated with protocol B may include frequency resources (e.g., resource blocks, resource elements, at least one frequency band, etc.) that are shared by the first set of frequency bands associated with protocol A. If desired, the second set of frequency bands may also include frequency resources (e.g., resource blocks, resource elements, at least one frequency band, etc.) that are different from the frequency resources of the first set of frequency bands associated with protocol A.

If desired, chipset 64B may transmit radio-frequency signals that do not carry wireless data. If desired, chipset 64B may forego reception of radio-frequency signals (e.g., chipset 64B may include a transmitter that transmits radio-frequency signals and may not include any receivers receive radio-frequency signals). Alternatively, if desired, chipset 64B may include a receiver that receives radio-frequency signals over antenna 42B and radio-frequency transmission line path 36B. The receiver may receive the radio-frequency signals according to, under, using, and/or based on protocol B and radio access technology RATB. Chipset 64B may recover, decode, demodulate, and/or otherwise identify wireless data and/or other baseband data from the received radio-frequency signals according to, under, using, and/or based on protocol B. Protocol B may be a UWB protocol, a WLAN protocol (e.g., a Wi-Fi 6 or Wi-Fi 7 protocol), a cellular telephone protocol, a device-to-device (D2D) protocol, a satellite navigation protocol, a satellite communications protocol, or any other desired wireless communications protocol that is different from protocol A.

Chipset 64A and antenna 42A may, for example, convey first radio-frequency signals 56 (FIG. 2) such as radio-frequency signals 56A between wireless circuitry 24 and first external communications equipment 54A (e.g., a first external device, AP, BS, etc.) using protocol A and radio access technology RATA. Chipset 64B and antenna 42B may, for example, convey second radio-frequency signals 56 (FIG. 2) such as radio-frequency signals 56B between wireless circuitry 24 and first external communications equipment 54B (e.g., a second external device, AP, BS, etc.) using protocol B and radio access technology RATB. If desired, chipset 64B may convey radio-frequency signals 56B concurrent with chipset 64A conveying radio-frequency signals 56A.

While performing object detection, chipset 64B may generate a first radio-frequency signal (sigtx) (e.g., a sensing signal such as sensing signal 60 of FIG. 2) for use in object detection. Chipset 64B may generate radio-frequency signal sigtx according to, under, based on, or using protocol B and radio access technology RATB. Chipset 64B may transmit radio- frequency signal sigtx over radio-frequency transmission line path 36B and antenna 42B (e.g., using frequency resources of the second set of frequency bands associated with protocol B).

Radio-frequency signal sigtx may include a waveform associated with or specified by protocol B. Radio-frequency signal sigtx may carry wireless communications data, may be free from wireless communications data, may include one or more orthogonal frequency division multiplexing (OFDM) symbols, may include a radio-frequency signal 56B intended for receipt by external communications equipment 54B, may be different than the radio-frequency signals 56B intended for receipt by external communications equipment 54B and/or other external communications equipment (e.g., radio-frequency signal sigtx may be a dedicated sensing signal that is not intended for receipt by external communications equipment), may include a series of one or more pilot, beacon, reference, control, and/or management signals, symbols, frames, or packets, and/or may include a series of one or more signal pulses (e.g., in implementations where protocol B is a UWB protocol), as examples. As one more specific example, protocol B may be a WLAN protocol and radio-frequency signal sigtx may include OFDM symbols transmitted under the WLAN protocol (e.g., for receipt by external communications equipment 54B). As shown by arrow 66, some or all of the electromagnetic energy of the radio-frequency signal sigtx transmitted by antenna 42B may be received at antenna 42A as second radio- frequency signal (sigrx) (e.g., sensing signal 62 of FIG. 2). Radio-frequency transmission line path 36A may pass radio-frequency signal sigrx to chipset 64A. The received radio-frequency signal sigrx may include electromagnetic energy from the transmitted radio-frequency signal sigtx that is received over-the-air (OTA), via near-field electromagnetic coupling between antennas 42A and 42B, via on-chip leakage, and/or that has reflected off one or more external objects 58.

Chipset 64A may receive radio-frequency signal sigrx over radio-frequency transmission line path 36A using protocol A and radio access technology RATA. Chipset 64A may convert the received radio-frequency signal into digital baseband data such as baseband samples bbsamp (e.g., according to protocol A). Chipset 64A may be communicatively coupled to processing circuitry 70 (e.g., a processor 26 of FIG. 2, processing circuitry 18 of FIG. 1, etc.) via baseband path 68 (e.g., a path 34 of FIG. 2). Processing circuitry 70 may also be communicatively coupled to chipset 64B if desired. Chipset 64A may pass baseband samples bbsamp to processing circuitry 60 over baseband path 68. Processing circuitry 70 may process baseband samples bbsamp to detect the presence, location, orientation, and/or velocity (motion) of external object 58 relative to wireless circuitry 24.

In some implementations, processing circuitry 70 may perform occlusion detection for antenna 42B using a CIR estimation scheme. In these implementations, baseband circuitry in chipset 64A may generate a baseband CIR signal (sometimes also referred to simply as a CIR of radio-frequency signal sigrx) based on the radio-frequency signal sigrx received from antenna 42A (e.g., by correlating the received radio-frequency signal sigrx with the corresponding transmitted radio-frequency signal sigtx transmitted by chipset 64B). Baseband samples bbsamp may represent, identify, and/or carry the CIR generated by chipset 64A. Plot 72 of FIG. 3 illustrates the signal level (magnitude) of the CIR generated by chipset 64A as a function of time. Plot 75 of FIG. 3 illustrates the phase of the CIR generated by chipset 64A as a function of time.

External object 58 is sometimes referred to herein as "occluding" an antenna when the external object overlaps and/or at least partially blocks the antenna from being able to transmit and/or receive radio-frequency signals. At a first time TA, external object 58 does not overlap, block, or otherwise occlude antenna 42A. Pulse 74 in plot 72 illustrates the magnitude of the CIR generated by chipset 64A from the radio-frequency signal sigrx received by antenna 42A while external object 58 does not occlude antenna 42A. At a second time TB, external object 58 blocks, overlaps, and/or otherwise occludes antenna 42A. This may alter the electromagnetic energy from the transmitted radio-frequency signal sigtx that is received by antenna 42B. This alteration may cause chipset 64A to produce a CIR having an altered or distorted magnitude shown by pulse 76 in plot 72.

Occlusion of antenna 42A by external object 58 may also change the phase of the CIR generated by chipset 64A from radio-frequency signal sigrx. Curve 77 of FIG. 3 plots the phase of the CIR generated by chipset 64A over time in the absence of occlusion of antenna 42A by external object 58. Curve 71 of FIG. 3 plots the phase of the CIR generated by chipset 64A over time while antenna 42A is occluded by object 58. As shown by curves 71 and 77, occlusion of antenna 42A may cause the phase of the CIR to fall below threshold curve 73 over a corresponding time period.

Processing circuitry 70 may process the CIR generated by chipset 64A (e.g., digital CIR samples) to detect whether external object 58 is occluding antenna 42A. For example, processing circuitry 70 may compare the magnitude and/or phase of the CIR over a corresponding time period to one or more thresholds and/or to one or more predetermined or calibrated CIR magnitudes/phases or pulse shapes (e.g., associated with antenna 42A being occluded or un-occluded) to determine whether or not antenna 42A is occluded by external object 58. If/when, for example, the CIR is sufficiently similar to a predetermined CIR associated with antenna 42A being occluded by external object 58, processing circuitry 70 may determine or identify that antenna 42A is occluded by external object 68. If/when the CIR is sufficiently similar to a predetermined CIR associated with antenna 42A not being occluded by external object 58, processing circuitry 70 may determine or identify that antenna 42A is not occluded by external object 68. As one simple example, processing circuitry 70 may determine that external object 58 is occluding antenna 42A if/when the phase of the CIR generated by chipset 64A falls below threshold curve 73 over a predetermined time period and may determine that external object 58 is not occluding antenna 42A if/when the phase of the CIR generated by chipset 64A exceeds threshold curve 73 during the predetermined time period.

If desired, processing circuitry 70 may include or implement a machine learning engine that compares the generated CIR (e.g., magnitude pulses as shown by plot 72 and/or phase as shown by plot 75) to a trained CIR model associated with the presence or absence of external object 58 and/or may use the generated CIR to further train or update the CIR model. This example in which processing circuitry 70 processes CIR to determine/detect whether antenna 42A is being occluded by external object 58 (a process sometimes also referred to herein as occlusion detection) is illustrative and non-limiting. If desired, processing circuitry 70 may process the CIR and/or baseband samples bbsamp to identify/detect the location of external object 58 (e.g., range R of FIG. 2), the motion or velocity of external object 58, and/or any other desired characteristics of external object 58. As another example, processing circuitry 70 may extract (e.g., generate, calculate, derive, produce, compute, etc.) one or more characteristics of the generated CIR (e.g., using corresponding signal processing techniques) and may detect the external object based on the extracted characteristic(s) (e.g., by comparing the extracted characteristic(s) to one or more predetermined values or thresholds of those characteristic(s) and/or by inputting the extracted characteristic(s) to a machine learning engine). The extracted characteristic(s) may include channel energy, channel smoothness, maximum CIR magnitude, and/or other characteristics.

Processing circuitry 70 may output a detection signal detsig indicative of the object detection or occlusion detection performed by processing circuitry 60. Detection signal detsig may, for example, identify whether or not external object 58 is occluding antenna 42A, may include location information associated with external object 58 (e.g., range R of FIG. 2), and/or any other desired object detection result or information. One or more software applications (e.g., as executed by an applications processor in processing circuitry 18 of FIG. 1 and/or an operating system of device 10) may perform any desired operations based on detection signal detsig. For example, control circuitry 14 (FIG. 1) may switch antenna 42A out of use, may reduce the transmit power level of antenna 42A, may reduce the maximum transmit power level of antenna 42A, may adjust beam steering performed by antenna 42A, may adjust the tuning of antenna 42A, and/or may adjust the impedance matching of antenna 42A in response to detecting that external object 58 is occluding antenna 42A (e.g., to help ensure that antenna 42A continues to satisfy regulatory requirements on electromagnetic energy exposure and/or to help ensure that wireless circuitry 24 is still able to perform satisfactory wireless communications with external communications equipment 54A despite the occlusion of antenna 42A by external object 58).

If desired, the circuitry of chipset 64A that processes radio-frequency signals compliant with protocol A (e.g., radio-frequency signal 56A) may also be used to perform signal processing that generates a CIR signal based on radio-frequency signals compliant with protocol B (e.g., using pilot signals of protocol B included in the transmitted radio-frequency signal sigtx). To help chipset 64A of protocol A to be able to generate a suitable CIR signal based on the received radio-frequency signal sigrx of protocol B, protocol A and protocol B may both be protocols that permit communication over a shared or common frequency band (e.g., the first set of frequency bands associated with protocol A may include at least one frequency band that belongs to the second set of frequency bands associated with protocol B). Put differently, chipset 64B may transmit radio-frequency signal sigtx in a frequency band that is shared by both protocols A and B. In addition, the bandwidth of radio-frequency signal sigtx may be compliant with and/or supported by both protocols A and B (e.g., such that the RFFE, antenna, and other hardware in both signal pathways maintain the integrity of signals sigtx/sigrx without any loss of information).

As one example, protocol A may be a UWB (e.g., IEEE 802.15.4) protocol and protocol B may be a WLAN protocol such as Wi-Fi 6E (e.g., IEEE 802.11 ax). In this example, both protocols A and B support signal transmission at least in Unlicensed National Information Infrastructure bands 1-6. In addition, protocol B (e.g., Wi-Fi 802.11 ax) may specify signal transmission bandwidths of around 80 MHz or around 160 MHz. On the other hand, protocol A (e.g., UWB 802.15.4) specifies a signal transmission bandwidth of around 500 MHz, which is sufficiently close to the 160 MHz bandwidth supported by protocol B so as to allow chipset 64A to perform Wi-Fi 6E CIR estimation on the received radio-frequency signal sigrx. This is illustrative and non-limiting and, in general, protocols A and B may be any desired protocols that share at least one frequency band and that support bandwidths that are sufficiently close to each other.

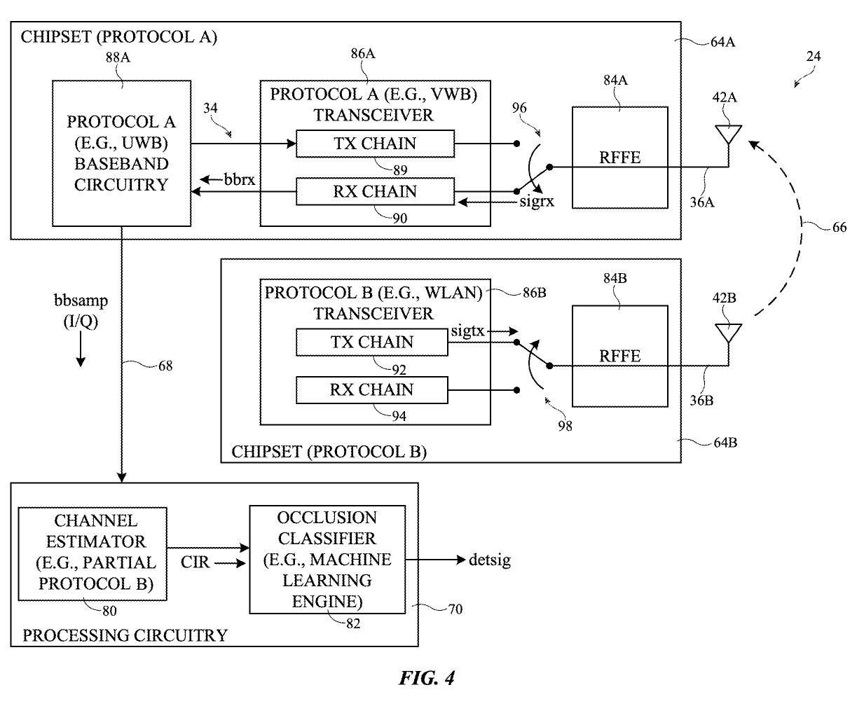

The example of FIG. 3 in which chipset 64A generates a CIR from radio-frequency signal sigrx is illustrative and non-limiting. FIG. 4 illustrates another example in which CIR estimation is offloaded from chipset 64A onto processing circuitry 70. In the example of FIG. 4, chipset 64A includes both a transmitter and a receiver for transmitting and receiving signals (e.g., under a time division duplexing (TDD) scheme) and chipset 64B includes both a transmitter and a receiver for transmitting and receiving signals (e.g., under a TDD scheme). This is illustrative and non-limiting.

As shown in FIG. 4, chipset 64A may include baseband circuitry 88A (e.g., forming part of a first processor 26 of FIG. 2), transceiver circuitry 86A (e.g., forming part of a first transceiver 28 of FIG. 2), switching circuitry 96, and RFFE circuitry 84A (e.g., forming part of a first FEM 40 of FIG. 2 or integrated into the first transceiver 28 of FIG. 2). Baseband circuitry 88A, transceiver circuitry 86A, and RFFE circuitry 84A may be implemented or disposed on three respective IC chips, two or more of baseband circuitry 88A, transceiver circuitry 86A, and RFFE circuitry 84A may be integrated onto a single IC chip, or all three of baseband circuitry 88A, transceiver circuitry 86A, and RFFE circuitry 84A may be integrated into the same IC chip (e.g., where the one or more IC chips form chipset 64A).

Baseband circuitry 88A, transceiver 86A, switching circuitry 96, and RFFE circuitry 84A may include hardware and/or software that implements protocol A. Transceiver 86A, switching circuitry 96, and RFFE 84A may implement radio access technology RATA. Radio- frequency transmission line path 36A may couple a first terminal of switching circuitry 96 to antenna 42A. RFFE 84A may be disposed on radio-frequency transmission line path 36A. Transceiver 86A may include transmitter circuitry (e.g., in a first transmitter 30 of FIG. 2) that includes transmit (TX) chain 89 (sometimes also referred to herein as transmit path 89). Transceiver 86A may include receiver circuitry (e.g., in a first receiver 32 of FIG. 2) that includes receive (RX) chain 90 (sometimes also referred to herein as receive path 90).

The input of transmit chain 89 and the output of receive chain 90 may be coupled to baseband circuitry 88A over paths 34. The output of transmit chain 89 may be coupled to a second terminal of switching circuitry 96. The input of receive chain 90 may be coupled to a third terminal of switching circuitry 96. Switching circuitry 96 may have a first state in which switching circuitry 96 couples radio-frequency transmission line path 36A to receive chain 90 while transmit chain 89 is decoupled from radio-frequency transmission line path 36A. Switching circuitry 96 may have a second state in which switching circuitry 96 couples radio- frequency transmission line path 36A to transmit chain 89 while receive chain 90 is decoupled from radio-frequency transmission line path 36A. Chipset 64A may transmit radio-frequency signals while switching circuitry 96 is in the second state. Chipset 64A may receive radio- frequency signals while switching circuitry 96 is in the first state.

Chipset 64B may include transceiver circuitry 86B (e.g., forming part of a second transceiver 28 of FIG. 2), switching circuitry 98, and RFFE circuitry 84B (e.g., forming part of the first FEM, a second FEM 40 of FIG. 2, or integrated into the second transceiver 28 of FIG. 2). Transceiver circuitry 86A and RFFE circuitry 84A may be implemented or disposed on two different respective IC chips or may both be integrated onto a single IC chip (e.g., where the one or more IC chips form chipset 64B). Transceiver 86B, switching circuitry 98, and RFFE circuitry 84B may include hardware and/or software that implements protocol B. Transceiver 86B, switching circuitry 98, and RFFE 84B may implement radio access technology RATB. Radio-frequency transmission line path 36B may couple a first terminal of switching circuitry 98 to antenna 42B. RFFE 84B may be disposed on radio-frequency transmission line path 36B. Transceiver 86B may include transmitter circuitry (e.g., in a second transmitter 30 of FIG. 2) that includes transmit (TX) chain 92 (sometimes also referred to herein as transmit path 92). Transceiver 86B may include receiver circuitry (e.g., in a second receiver 32 of FIG. 2) that includes receive (RX) chain 94 (sometimes also referred to herein as receive path 94).

The output of transmit chain 92 may be coupled to a second terminal of switching circuitry 98. The input of receive chain 94 may be coupled to a third terminal of switching circuitry 98. Switching circuitry 98 may have a first state in which switching circuitry 98 couples radio-frequency transmission line path 36B to receive chain 94 while transmit chain 92 is decoupled from radio-frequency transmission line path 36B. Switching circuitry 98 may have a second state in which switching circuitry 98 couples radio-frequency transmission line path 36B to transmit chain 92 while receive chain 94 is decoupled from radio-frequency transmission line path 36B. Chipset 64B may transmit radio-frequency signals while switching circuitry 98 is in the second state. Chipset 64B may receive radio-frequency signals while switching circuitry 98 is in the first state.

Processing circuitry 70 may include a channel estimator 80 and an occlusion classifier 82. Channel estimator 80 may, for example, form a partial receiver of protocol B that is configured to generate a CIR based on baseband signals of protocol A received from chipset 64A. Channel estimator 80 may, for example, use at least some specifications of communication protocol B to generate the CIR from the baseband samples that were generated using protocol A by chipset 64A. For example, channel estimator 80 may derive the CIR from pilot signals of protocol B that are present in the baseband samples received from chipset 64A. Occlusion classifier 82 may include comparison logic, lookup tables, memory, one or more machine learning engines, etc. Channel estimator 80 and occlusion classifier 82 may be implemented using hardware and/or software. As one example, an operating system of device 10 (e.g., as executed by processing circuitry 70) may perform some or all of the operations and functions of channel estimator 80 and occlusion classifier 82.

During object detection operations, switching circuitry 98 is placed in its second state and switching circuitry 96 is placed in its first state. Transmit chain 92 may include a digital-to- analog converter (DAC) that converts digital baseband data into an analog signal according to protocol B. Transmit chain 92 may include mixer circuitry that upconverts the analog signal to radio frequencies according to protocol B, producing radio-frequency signal sigtx (e.g., modulating the analog signal onto a radio-frequency carrier in a frequency band that is shared by protocols A and B). Transmit chain 92 may transmit radio-frequency signal sigtx. Switching circuitry 98 may pass radio-frequency signal sigtx onto radio-frequency transmission line path 36B. Radio-frequency transmission line path 36B may carry radio-frequency signal sigtx to antenna 42B. Antenna 42B may radiate radio-frequency signal sigtx.

As shown by arrow 66, at least some of the transmitted radio-frequency signal may be received at antenna 42A (as radio-frequency signal sigrx). Radio-frequency transmission line path 36A may pass radio-frequency signal sigrx to receive chain 90 via switching circuitry 96. Receive chain 90 may include mixer circuitry that downconverts radio-frequency signal sigrx to baseband according to protocol B. Receive chain 90 may include an ADC that converts the baseband signal from the analog domain to the digital domain according to protocol B, producing digital baseband signal bbrx. Receive chain 90 may pass digital baseband signal bbrx to baseband circuitry 88A via path 34. Baseband circuitry 88A may sample digital baseband signal bbrx onto baseband path 68 (e.g., dumping samples of digital baseband signal bbrx onto baseband path 68 as baseband samples bbsamp). Baseband samples bbsamp may, for example, include in-phase and quadrature-phase (I/Q) samples.

Channel estimator 80 in processing circuitry 60 may receive baseband samples bbsamp from chipset 64A via baseband path 68. Channel estimator 80 may serve as a digital receiver that partially implements protocol B. Channel estimator 80 may generate, calculate, identify, or produce a CIR over time from baseband samples bbsamp (e.g., for the received radio-frequency signal sigrx). The generated CIR may include a CIR magnitude (see, e.g., plot 72 of FIG. 3) and/or a CIR phase (see, e.g., plot 75 of FIG. 3). Occlusion classifier 82 may receive the generated CIR and may generate detection signal detsig based on the generated CIR (e.g., by comparing the generated CIR to predetermined/calibrated CIR values, by comparing the generated CIR to one or more thresholds, by inputting the generated CIR to a machine learning model, etc.).

When implemented in this way, chipset 64A may transfer its acquired ADC-converted signal over a given transfer period to another software entity running on device 10 (e.g., executed by processing circuitry 70) such as an operating system that performs the operations of channel estimator 80 and occlusion classifier 82. Channel estimator 80 may serve as a partial receiver that processes baseband samples bbsamp to derive the CIR in non-real-time. Note that even though real-time processing of the signal to derive CIR is not required, the software executed by processing circuitry 70 (e.g., the operating system of device 10) may be able to implement a faster CE block than chipset 64A itself. Put differently, offloading CIR estimation to processing circuitry 70 may speed up processing relative to the implementation of FIG. 3.

The examples of FIGS. 3 and 4 in which a CIR is generated from the received radio- frequency signal sigrx for use in object detection is illustrative and non-limiting. In general, processing circuitry 70 may perform any desired processing on the baseband samples bbsamp output by chipset 64A to perform occlusion detection or any other desired object detection operations on external object 58 (e.g., radar object detection, location detection, motion detection, gesture detection, etc.). If desired, protocol B may be a spatial ranging protocol such as a radar protocol. In other implementations, the radio-frequency signal sigtx transmitted by chipset 64B may not be compliant with protocol B or any particular communications protocols (e.g., chipset 64B need not implement protocol B or any communications protocol). If desired, chipset 64B may include a signal generator or synthesizer that generates radio-frequency signal sigtx as a spatial ranging waveform such as a frequency modulated continuous wave (FMCW) waveform, an OFDM radar waveform, or another radar waveform, as a linear frequency ramp (e.g., chirp signal), as one or more tones (e.g., sinusoidal waveforms), as sawtooth signals, as step function signals, as square wave signals, and/or any as any other desired signals or waveforms for use in performing object detection. In some implementations where radio- frequency signal sigtx is transmitted as a tone, protocol B may be a Wi-Fi protocol, radio- frequency signals 56B (FIG. 3) may include OFDM symbols transmitted under the Wi-Fi protocol (e.g., for receipt by external communications equipment 54B), and radio-frequency signal sigtx may include a tone that is transmitted periodically or occasionally by chipset 64B instead of an OFDM symbol (e.g., between two OFDM symbols in a series of transmitted OFDM symbols, during time periods scheduled by an AP for device 10 to transmit a tone instead of an OFDM symbol or as inserted into transmissions by device 10 independent of scheduling performed by the AP).

If desired, chipset 64A may include a signal receiver or detector that does not implement protocol A or any communications protocol. In these implementations, rather than performing CIR estimation and analysis, chipset 64A may forego decoding of radio-frequency signal sigrx and may instead detect the amount of electromagnetic energy present in the received radio-frequency signal sigrx. The signal receiver may, for example, generate an output indicative of the amount of electromagnetic energy present in radio-frequency signal sigrx, processing circuitry 70 may compare the output to a threshold, processing circuitry 70 may determine that antenna 42A is occluded by external object 58 if/when the amount of electromagnetic energy identified by the output exceeds a threshold, and processing circuitry 70 may determine that antenna 42A is not occluded by external object 58 if/when the amount of electromagnetic energy identified by the output is less than the threshold. This may be generalized to the creation and processing of any desired metric detectable from radio-frequency signal sigrx that is indicative of whether antenna 42A is occluded by external object 58.

By performing CP object detection (e.g., occlusion detection) in this way, wireless circuitry 24 may detect external object 58 with as few as a single antenna 42 per chipset 64 (e.g., a single transmit antenna coupled to a single transmitter and a single receive antenna coupled to a single receiver), helping to reduce area consumption and cost while increasing power efficiency. In addition, wireless circuitry 24 may perform object detection with less leakage and improved interference rejection relative to implementations where two antennas coupled to the same chipset use the same RAT for transmitting and receiving sensing signals.

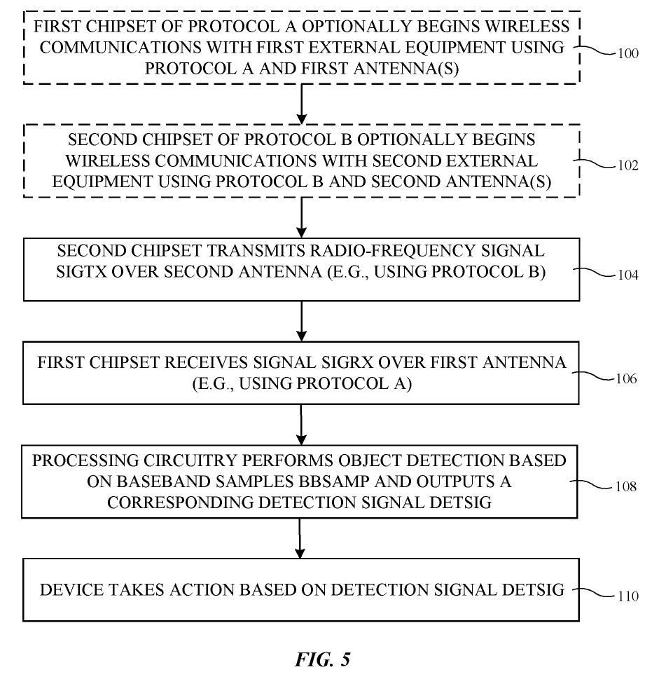

FIG. 5 is a flow chart of illustrative operations that may be performed by wireless circuitry 24. At optional operation 100, chipset 64A may begin performing wireless communications with external communications equipment 54A using protocol A and antenna 42A. This may include conveying radio-frequency signals 56A between chipset 64A and external communications equipment 54A according to protocol A. If desired, chipset 64A may continue to convey radio-frequency signals 56A with external communications equipment 54A concurrent with, before, and/or after one or more of the remaining operations of FIG. 5. Operation 100 may be omitted if desired (e.g., in implementations where chipset 64A performs object detection using spatial ranging signals or without utilizing a corresponding communications protocol).

At optional operation 102, chipset 64B may begin performing wireless communications with external communications equipment 54B using protocol B and antenna 42B. This may include conveying radio-frequency signals 56B between chipset 64B and external communications equipment 54B according to protocol B. If desired, chipset 64B may continue to convey radio-frequency signals 56B with external communications equipment 54B concurrent with, before, and/or after one or more of the remaining operations of FIG. 5. Operation 102 may be omitted if desired (e.g., in implementations where chipset 64B performs object detection using spatial ranging signals or without utilizing a corresponding communications protocol).

At operation 104, chipset 64B may generate and transmit radio-frequency signal sigtx using antenna 42B.

At operation 106, chipset 64A may receive radio-frequency signal sigrx using antenna 42A.

At operation 108, processing circuitry 70 and/or chipset 64A may perform object detection based on the received radio-frequency signal sigrx. Chipset 64A may, for example, generate baseband samples bbsamp based on radio-frequency signal sigrx. Processing circuitry 70 may use baseband samples bbsamp to perform object detection on external object 58 (e.g., to determine whether antenna 42A is occluded by external object 58). As one example, chipset 64A may generate a CIR of the received radio-frequency signal sigrx and may transmit baseband samples bbsamp of the generated CIR to processing circuitry 70. Processing circuitry 70 may perform any desired object detection operations (e.g., occlusion detection) based on the received CIR. As another example, processing circuitry 70 may generate the CIR of the received radio- frequency signal based on baseband samples bbsamp received from chipset 64A (e.g., as shown in FIG. 4). If desired, processing circuitry 70 may generate and/or output a detection signal detsig based on the object detection.

At operation 110, device 10 may perform one or more actions based on the object detection performed by processing circuitry 70. This may include, for example, switching antenna 42A into or out of use, adjusting beam steering of antenna 42A or other antennas of a phased antenna array, adjusting the tuning and/or impedance matching of antenna 42A, adjusting a transmit power level of antenna 42A and/or other antennas in device 10, adjusting a maximum transmit power level of antenna 42A and/or other antennas in device 10, switching one or more antennas 42 into use, identifying a user input gesture, generating a spatial map of the surroundings of device 10, and/or any other desired action based on the detection of, presence of, occlusion by, and/or location of external device 10 as detected using radio-frequency signals sigtx and sigrx.

The methods and operations described above in connection with FIGS. 1-5 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random- access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

As used herein, the term "concurrent" means at least partially overlapping in time. In other words, first and second events are referred to herein as being "concurrent" with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non- simultaneous (e.g., if the first event starts before or after the start of the second event, if the first event ends before or after the end of the second event, or if the first and second events are partially non-overlapping in time). As used herein, the term "while" is synonymous with "concurrent."

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Circuitry comprising:
a first antenna;
a transmitter communicatively coupled to the first antenna, wherein the transmitter implements a first radio access technology (RAT) and is configured to transmit a radio-frequency signal using the first RAT and the first antenna;
a second antenna;
a receiver communicatively coupled to the second antenna, wherein the receiver implements a second RAT that is different from the first RAT and is configured to receive, using the second antenna, the radio-frequency signal transmitted by the transmitter; and
one or more processors configured to detect an external object based on the radio-frequency signal received by the receiver.

2. The circuitry of claim 1, wherein the receiver is configured to generate a channel impulse response (CIR) based on the radio-frequency signal received by the receiver, the one or more processors being configured to detect the external object based on the CIR.

3. The circuitry of claim 2, the one or more processors being configured to detect the external object by comparing a phase of the CIR over time to a predetermined phase over time.

4. The circuitry of claim 2, the one or more processors being configured to detect the external object by comparing a magnitude of the CIR over time to a predetermined magnitude over time.

5. The circuitry of claim 2, the one or more processors being configured to detect the external object by inputting the CIR to a machine learning engine.

6. The circuitry of claim 2, the one or more processors being configured to:
extract a characteristic from the CIR; and
detect the external object based on the extracted characteristic, wherein the extracted characteristic comprises a channel energy, a channel smoothness, or a maximum CIR magnitude.

7. The circuitry of claim 1, wherein the receiver is configured to generate a stream of baseband samples based on the radio-frequency signal received by the receiver, the one or more processors being further configured to:
receive the stream of baseband samples from the receiver over a baseband path;
detect the external object based on the stream of baseband samples;
generate a channel impulse response (CIR) based on the stream of baseband samples; and
detect the external object based on the CIR.

8. The circuitry of claim 1, wherein the transmitter is configured to transmit first wireless data to first external communications equipment using the first RAT and the first antenna and wherein the receiver is configured to receive second wireless data from second external communications equipment using the second RAT and the second antenna.

9. The circuitry of claim 8, wherein the radio-frequency signal carries the first wireless data.

10. The circuitry of claim 1, wherein the transmitter is configured to transmit the radio-frequency signal in a frequency band that is shared by the first RAT and the second RAT.

11. The circuitry of claim 10, wherein the first RAT comprises a wireless local area network (WLAN) RAT, the second RAT comprises an ultra-wideband (UWB) RAT, and the frequency band comprises an Unlicensed National Information Infrastructure band.

12. The circuitry of claim 1, wherein the first RAT comprises a wireless local area network (WLAN) RAT, the transmitter is configured to transmit a series of orthogonal frequency division multiplexing (OFDM) symbols to a wireless access point using the first antenna, and the radio-frequency signal comprises a tone transmitted by the transmitter between two OFDM symbols from the series of OFDM symbols.

13. Wireless communications circuitry comprising:
a first chipset configured to transmit, using a first antenna, a radio-frequency signal according to a first communications protocol;
a second chipset configured to
receive, using a second antenna and a second communications protocol that is different than the first communications protocol, the radio-frequency signal transmitted by the first chipset, and
generate baseband samples based on the radio-frequency signal received using the second communications protocol; and
one or more processors configured to detect an external object based on the baseband samples generated by the second chipset.

14. The wireless circuitry of claim 13, the one or more processors being configured to detect, based on the baseband samples generated by the second chipset, whether the external object is occluding the second antenna.

15. The wireless circuitry of claim 13, wherein the radio-frequency signal transmitted by the first chipset comprises wireless data transmitted to a wireless access point or a wireless base station.

16. The wireless circuitry of claim 15, wherein:
the first chipset comprises a first transceiver that includes a first transmit chain and a first receive chain, a first switch, and a first radio-frequency transmission line path,
the first transceiver implements the first communications protocol,
the first switch has a first terminal, a second terminal, and a third terminal,
the first transmit chain is coupled to the first terminal,
the first receive chain is coupled to the second terminal,
the first radio-frequency transmission line path couples the third terminal to the first antenna,
the first transmit chain is configured to generate the radio-frequency signal according to the first communications protocol,
the second chipset comprises a second transceiver that includes a second transmit chain and a second receive chain, a second switch, baseband circuitry, and a second radio-frequency transmission line path,
the second transceiver and the baseband circuitry implement the second communications protocol,
the second switch has a fourth terminal, a fifth terminal, and a sixth terminal,
the second transmit chain is coupled to the fourth terminal,
the second receive chain is coupled to a fifth terminal,
the second radio-frequency transmission line path couples the sixth terminal to the second antenna,
the second receive chain is configured to receive the radio-frequency using the second communications protocol,
the baseband circuitry is configured to generate the baseband samples,
the one or more processors are configured to generate a channel impulse response (CIR) based on the baseband samples, and
the one or more processors are configured to detect the external object based on the CIR.

17. The wireless circuitry of claim 13, wherein the second chipset comprises:
baseband circuitry configured to generate a channel impulse response (CIR) based on the radio-frequency signal received using the second communications protocol, the one or more processors being configured to detect the external object based on the CIR.

18. The wireless communications circuitry of claim 13, wherein the first communications protocol supports communications in a first set of frequency bands, the second communications protocol supports communications in a second set of frequency bands, and the first chipset is configured to transmit the radio-frequency signal in a frequency band that is shared by both the first set of frequency bands and the second set of frequency bands.

19. A method of operating wireless circuitry comprising:
transmitting, using a first modem and a first antenna, a radio-frequency signal according to a first wireless communications protocol;
receiving, using a second modem and a second antenna, the radio-frequency signal according to a second wireless communications protocol that is different from the first wireless communications protocol;
generating, using the second modem, baseband samples based on the received radio-frequency signal; and
detecting, using one or more processors, occlusion of the second antenna by an external object based on the baseband samples.

20. The method of claim 19, further comprising:
conveying, using the first modem and the first antenna, first wireless data with a first external device according to the first wireless communications protocol; and
conveying, using the second modem and the second antenna, second wireless data with a second external device according to the second wireless communications protocol.
